(19) United States
(12) Patent Application Publication
(10) Pub. No.: US 2026/0337993 A1
(43) Pub. Date: Oct. 29, 2026

(54) CLEANING METHOD FOR UNDERWATER ROBOT,UNDERWATER ROBOT, AND STORAGE MEDIUM

(71) Applicant: Shenzhen Seauto Technology Co., Ltd., Shenzhen (CN)

(72) Inventor: Zhineng Deng, Shenzhen, Guangdong (CN)

(21) Appl. No.: 18/995,358

(22) PCT Filed: May 29, 2023
(86) PCT No.: PCT/CN2023/096909

§ 371 Date: Jan. 16, 2025

(30) Foreign Application Priority Data
May 16, 2023 (CN) 202310550938.X

(51) Int. Cl. E04H 4/16

(52) U.S. Cl. CPC E04H 4/1654

(57) ABSTRACT

A cleaning method applied to an underwater robot, an underwater robot, and a storage medium. The method includes the following steps: acquiring historical cleaning data of an underwater robot; determining a current clogging value of a filter screen according to the historical cleaning data; and when the underwater robot executes a climbing action and/or an obstacle avoidance action, determining a target value of a water pumping power according to the current clogging value, and executing the climbing action and/or the obstacle avoidance action according to the target water pumping power. The method solves the problem that the battery life of an underwater robot is reduced due to the fact that the water pumping power is directly adjusted to the maximum during wall climbing or obstacle avoidance.

The present application claims priority to Chinese Patent Application No. 202310550938.X, filed with the China National Intellectual Property Administration on May 16, 2023 and entitled “CLEANING METHOD FOR UNDERWATER ROBOT, UNDERWATER ROBOT, AND STORAGE MEDIUM”, which is incorporated herein by reference in its entirety.

### TECHNICAL FIELD

The present application relates to the field of cleaning robots, and in particular, to a cleaning method for an underwater robot, an underwater robot, and a storage medium.

### BACKGROUND

An underwater robot may be used for a variety of underwater operations, such as repeatedly cleaning the bottom, walls and waterlines of a swimming pool or filtering the water in the swimming pool. In the related art of underwater robots, when comprehensively cleaning the swimming pool, the underwater robot is generally controlled to clean in the sequence of a pool bottom-a pool wall. In the process of climbing to the pool wall, the underwater robot usually uses a fixed pumping power to perform the wall climbing action. The higher the water pumping power, the greater the amount of water discharged and the greater the climbing power.

However, the climbing power corresponding to the water pumping power is also affected by a filter screen in a water pumping mechanism. For example, after the pool bottom is cleaned, when more cleaned objects are accumulated in the filter screen, the amount of water discharged from the underwater robot is far lower than a fixed water pumping amount; consequently, the climbing power of the underwater robot at the current moment cannot make the underwater robot adhere to the pool wall for pool wall cleaning. Under the above described scenario, the underwater robot in the related art directly adjusts the water pumping power to the maximum to ensure the cleaning of the pool wall. However, this power adjustment method reduces the battery life of an underwater robot.

The above contents are only used to assist in understanding the technical solution of the present application and do not constitute an admission that the above contents are prior art.

### SUMMARY

### Technical Fields

The present application provides a cleaning method for an underwater robot, an underwater robot, and a storage medium, so that a battery life of an underwater robot is not affected due to direct adjustment of water pumping power to the maximum when the underwater robot executes wall climbing and/or obstacle avoidance.

### Technical Characteristics

The present application provides a cleaning method for an underwater robot. The cleaning method for the underwater robot includes the following steps:
acquiring historical cleaning data of the underwater robot;
determining a current clogging value of a filter screen according to the historical cleaning data; and
when the underwater robot executes a climbing action and/or an obstacle avoidance action, determining a target value of a water pumping power according to the current clogging value, and executing the climbing action and/or the obstacle avoidance action according to the target value of the water pumping power.

Optionally, determining the current clogging value of a filter screen according to the historical cleaning data includes:
determining a pool bottom cleaning time, a waterline cleaning time, and a pool wall cleaning time based on the historical cleaning data;
calculating a first congestion value according to the pool bottom cleaning time and a first congestion index, calculating a second congestion value according to the waterline cleaning time and a second congestion index, and calculating a third congestion value according to the pool wall cleaning time and a third congestion index; and
determining the current clogging value according to the first congestion value, the second congestion value and the third congestion value.

Optionally, before calculating the first congestion value according to the pool bottom cleaning time and the first congestion index, calculating the second congestion value according to the waterline cleaning time and the second congestion index, and calculating the third congestion value according to the pool wall cleaning time and a third congestion index, the method further includes:
if a pool wall cleaning mode and/or a waterline cleaning mode are executed before a pool bottom cleaning mode is executed, determining an index increment according to the waterline cleaning time and the pool wall cleaning time; and
determining the first congestion index according to a preset index and the index increment.

Optionally, before determining the target value of the water pumping power according to the current clogging value and executing the climbing action and/or the obstacle avoidance action according to the target value of the water pumping power, the method further includes:
when a climbing action executing condition is met, controlling the underwater robot to execute the climbing action, and/or executing the obstacle avoidance action when detecting an obstacle.

Optionally, determining the target value of the water pumping power according to the current clogging value and executing the climbing action and/or the obstacle avoidance action according to the target value of the water pumping power includes:
acquiring an initial value of the water pumping power corresponding to the climbing action and/or the obstacle avoidance action;
determining the target value of the water pumping power according to the initial value of the water pumping power and the current clogging value; and
executing the climbing action and/or the obstacle avoidance action according to the target value of the water pumping power.

Optionally, before determining a current clogging value of a filter screen according to the historical cleaning data, the method further includes:
determining a current cleaning state of the underwater robot;
determining a cleaning sequence for a pool bottom, a pool wall and a waterline based on the cleaning state and the historical cleaning data; and
executing a cleaning mode corresponding to the cleaning sequence according to the cleaning sequence.

Optionally, the cleaning mode is a waterline cleaning mode, and executing the cleaning mode corresponding to the cleaning sequence according to the cleaning sequence includes:
when a current position is not in a waterline area, controlling the underwater robot to climb to the waterline area;
when the current position is in the waterline area, turning off a left water pumping mechanism or a right water pumping mechanism of the underwater robot based on a preset cleaning route; and
when a first cleaning time of executing the waterline cleaning mode is greater than a first preset time and/or a heading angle of the underwater robot changes, controlling the underwater robot to switch to a pool wall cleaning mode.

Optionally, after controlling the underwater robot to switch to the pool wall cleaning mode when a first cleaning time for executing the waterline cleaning mode is greater than a first preset time and/or a heading angle of the underwater robot changes, the method further includes:
when a second cleaning time of executing the pool wall cleaning mode is greater than a second preset time and/or a number of cleaning failures of the pool wall cleaning is greater than or equal to a preset number, controlling the underwater robot to switch to a pool bottom cleaning mode.

In addition, to achieve the above objective, the present application further provides an underwater robot. The underwater robot includes a memory, a processor, and a cleaning program stored in the memory and capable of running on the processor, wherein when the cleaning program is executed by the processor, the processor executes instructions as follows:
acquiring historical cleaning data of the underwater robot;
determining a current clogging value of a filter screen according to the historical cleaning data; and
when the underwater robot executes a climbing action and/or an obstacle avoidance action, determining a target value of a water pumping power according to the current clogging value, and executing the climbing action and/or the obstacle avoidance action according to the target value of the water pumping power.

In addition, to achieve the above objective, the present application further provides a computer-readable storage medium on which a cleaning program of an underwater robot is stored, wherein when the cleaning program of the underwater robot is executed by a processor, the processor executes instructions as follows:
acquiring historical cleaning data of the underwater robot;
determining a current clogging value of a filter screen according to the historical cleaning data; and
when the underwater robot executes a climbing action and/or an obstacle avoidance action, determining a target value of a water pumping power according to the current clogging value, and executing the climbing action and/or the obstacle avoidance action according to the target value of the water pumping power.

### Beneficial Effects

Embodiments of the present application provide a cleaning method for an underwater robot, an underwater robot, and a storage medium. The method includes: firstly acquiring historical cleaning data of the underwater robot; then determining a current clogging value of a filter screen according to the historical cleaning data; and when the underwater robot executes a climbing action and/or an obstacle avoidance action, determining a target value of a water pumping power according to the current clogging value, and executing the climbing action and/or the obstacle avoidance action according to the target value of the water pumping power. It can be learned that historical cleaning data is acquired, and then a congestion value of a filter screen in a water pumping mechanism of an underwater robot is calculated according to the historical cleaning data; when the underwater robot needs to clean a pool wall, that is, to execute wall climbing and/or obstacle avoidance actions, water pumping power during wall climbing is dynamically adjusted based on the congestion value. This can avoid the situation where the underwater robot directly adjusts the water pumping power to the maximum when the climbing power provided by the fixed pumping power is insufficient or when obstacle avoidance is required, resulting in power overflow and reduced battery life. Meanwhile, this can also avoid the abnormal situation where the underwater robot easily slides to the pool bottom when climbing the wall based on the fixed pumping power when the filter screen is highly clogged, thereby improving the battery life of the underwater robot during cleaning and the efficiency of full coverage cleaning of the swimming pool.

### BRIEF DESCRIPTION OF DRAWINGS

The accompanying drawings herein are incorporated into the specification and constitute a part of the specification, show embodiments conforming to the present application, and are used together with the specification to explain a principle of the present application. To describe the technical solutions in the embodiments of the present application more clearly, the following briefly describes the accompanying drawings that need to be used in embodiments. Apparently, those of ordinary skill in the art may still derive other accompanying drawings from these accompanying drawings without creative efforts.

FIG. 1 is a schematic flowchart of a first embodiment of a cleaning method for an underwater robot according to the present application;

FIG. 2 is a schematic diagram of a relationship between a clogging value of a filter screen and cleaning time when an underwater robot cleans a pool bottom in a cleaning method for an underwater robot according to the present application;

FIG. 3 is a schematic flowchart of a second embodiment of a cleaning method for an underwater robot according to the present application;

FIG. 4 is a schematic flowchart of a third embodiment of a cleaning method for an underwater robot according to the present application; and

FIG. 5 is a schematic diagram of an embodiment of a terminal hardware structure of a cleaning method for an underwater robot according to the present application.

The realization of the objectives, the functional features, and the advantages of the present application will be further explained in conjunction with the embodiments and with reference to the drawings.

### DETAILED DESCRIPTION

It should be understood that the specific embodiments described herein are merely illustrative of the present application and do not limit the present application.

For a better understanding of the above technical solutions, the following describes exemplary embodiments of the present application in detail with reference to the accompanying drawings. Although exemplary embodiments of the present disclosure are shown in the accompanying drawings, it should be understood that the present disclosure can be implemented in various forms and should not be limited to the embodiments set forth herein. Rather, these embodiments are provided to enable a more thorough understanding of the present disclosure and to fully convey the scope of the present disclosure to those skilled in the art.

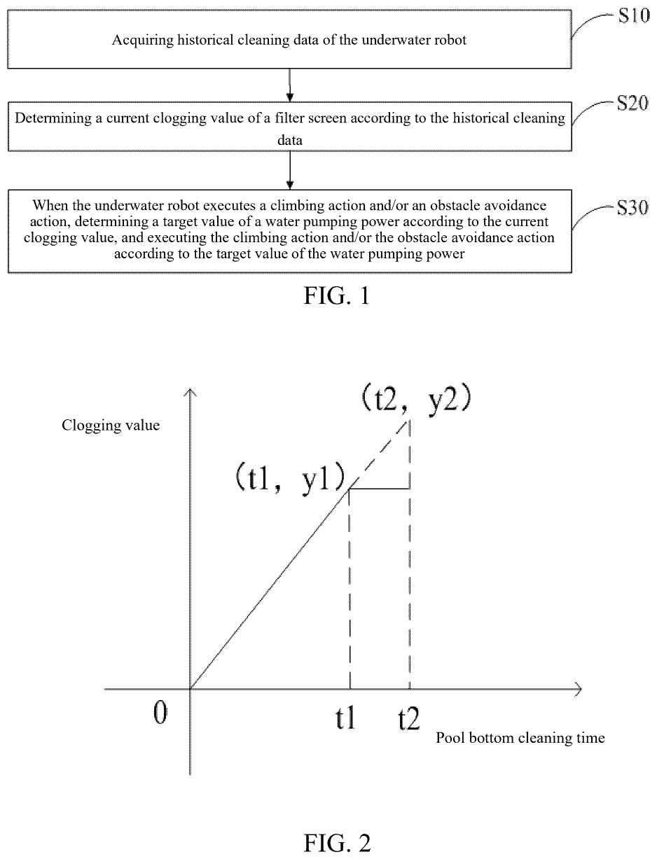

Referring to FIG. 1, FIG. 1 is a schematic flowchart of a first embodiment of a cleaning method for an underwater robot according to the present application.

The solution of this embodiment is applied to an underwater robot, such as a swimming pool cleaning robot. The swimming pool cleaning robot includes at least a cleaning component, a traveling motor, a water pumping motor with a filter screen, an inertial sensor such as an acceleration sensor, a distance sensor such as a laser point cloud radar and an infrared scanning radar, a water entry detection device, and a water exit detection device. The traveling motor is used to control the movement of the swimming pool cleaning robot. The water pumping motor is used to absorb sewage after cleaning and discharge the filtered sewage, and can also provide power for climbing walls and avoiding obstacles based on the discharged sewage. The power is related to the degree of clogging of the filter screen. The inertial sensor is used to obtain a pitch angle and an acceleration of the underwater robot. The distance sensor is used to determine a distance between a pool wall and a swimming pool cleaning robot. The water entry detection device is used to detect whether the underwater robot enters the water. The water exit detection device is used to detect whether the underwater robot exits a water surface. The water entry detection device and the water exit detection device can be different names for the same device.

In this embodiment, the cleaning method for the underwater robot includes the following steps:

Step S10: acquiring historical cleaning data of the underwater robot.

In this embodiment, a cleaning scenario of the underwater robot may be a swimming pool. The historical cleaning data refers to cleaning data of the underwater robot from the time the underwater robot executes the cleaning task to the current moment, which includes a pool bottom cleaning time, a waterline cleaning time, and a pool wall cleaning time. The waterline refers to a water level area of the swimming pool, and the pool wall refers to a to-be-cleaned wall area between the water level line and the pool bottom.

For example, the historical cleaning data acquired by the underwater robot includes 0 min of the pool wall cleaning time, 5 min of the waterline cleaning time, and 0 min of the pool bottom cleaning time. Based on this, it may be determined that the underwater robot executes the cleaning task only on the waterline after executing the cleaning task in the water. It should be noted that the above data is only used for explanation and is not intended to limit the present application.

When the underwater robot executes a cleaning task, the water pumping mechanism is in an operating state, the historical cleaning data may be acquired in real time, and then the clogging value of a filter screen in the water pumping mechanism is calculated based on the historical cleaning data. In this way, the underwater robot can dynamically adjust the operating power of the water pumping mechanism when executing a climbing action and/or an obstacle avoidance action, the phenomenon that the water pumping power is directly adjusted to the maximum to cause power overflow is avoided, and the battery life of the underwater robot when the underwater robot cleans a larger pool wall is further improved. It should be noted that, the underwater robot executing the climbing action means that the underwater robot needs to climb up to the pool wall from the pool bottom. It may be understood that the water pumping mechanism discharges the water filtered by the filter screen when pumping water, the water discharge rate is related to the water pumping power and the clogging value of the filter screen, the greater the water pumping power, the more water is discharged, and the greater the reverse power provided by the water pumping mechanism for the underwater robot. Based on this, when executing the climbing action or more urgent obstacle avoidance action, the underwater robot needs the power provided by the water pumping mechanism as support. If the clogging value of the filter screen is high, the less power provided for the water discharge causes the underwater robot to slide to the pool bottom when climbing to the wall, or the current power cannot support the underwater robot to climb to the pool wall.

Step S20: determining a current clogging value of a filter screen according to the historical cleaning data.

In the embodiment, the clogging value represents the clogging degree of the filter screen in the water pumping mechanism of the underwater robot. In the scenario of this embodiment, the clogging degree of the filter screen affects the water discharge rate, so that the power generated during water discharge cannot support the underwater robot to climb to the pool wall, or the underwater robot slide off the pool wall, which affects the cleaning efficiency of the pool wall. Meanwhile, the power generated by the underwater robot when discharging water can also provide corresponding auxiliary driving force for the underwater robot to execute emergency obstacle avoidance.

In this embodiment, the current clogging value of the filter screen may be obtained by adding a pool bottom clogging value, a pool wall clogging value, and a waterline clogging value. The pool bottom clogging value, the pool wall clogging value, and the waterline clogging value may be determined by the corresponding cleaning time and the corresponding clogging value of each area. That is, the step S20 specifically includes:

Step S21: determining a pool bottom cleaning time, a waterline cleaning time, and a pool wall cleaning time based on the historical cleaning data.

Step S22: calculating a first congestion value according to the pool bottom cleaning time and a first congestion index, calculating a second congestion value according to the waterline cleaning time and a second congestion index, and calculating a third congestion value according to the pool wall cleaning time and a third congestion index.

In this embodiment, the first congestion value is a pool bottom clogging value, and the first congestion index is a pool bottom clogging index; the second congestion value is a waterline clogging value, and the second congestion index is a waterline congestion index; and the third congestion value is a pool wall clogging value, and the third congestion index is a pool wall congestion index. The congestion index refers to a change index of the clogging value when the area is cleaned.

Specifically, a product of the pool bottom clogging index and the pool bottom cleaning time may be used as a pool bottom clogging value, a product of the pool wall congestion index and the pool wall cleaning time may be used as a pool wall congestion value, and a product of the waterline congestion index and the waterline cleaning time may be used as a waterline congestion value. The congestion index may be determined by a picture collector based on the collected image data. For example, before the swimming pool is cleaned, the captured swimming pool pictures are input into a picture analysis model, and the picture analysis model calculates the congestion index corresponding to the pool bottom, waterline and pool wall based on the swimming pool pictures.

Optionally, the pool bottom clogging index is related to the cleaning sequence of the underwater robot. For example, when the to-be-cleaned objects (such as moss and dust causing clogging) on the waterline and the pool wall are sucked into the underwater robot after the waterline and the pool wall are cleaned and then the pool bottom is cleaned, part of the to-be-cleaned objects directly fall to the pool bottom. Thus, the pool bottom clogging index increases when the pool bottom is cleaned later than other cleaning areas.

Specifically, before the step S22, the method further includes: if a pool wall cleaning mode and/or a waterline cleaning mode are executed before a pool bottom cleaning mode is executed, determining index increment according to the waterline cleaning time and the pool wall cleaning time; and determining the first congestion index according to a preset index and the index increment. The preset index refers to a preset congestion index of the pool bottom obtained based on the captured swimming pool pictures.

For example, if before the pool bottom cleaning mode is executed, the historical cleaning data includes 5 min of the waterline cleaning time, 0 min of the pool wall cleaning time, and 0 min of the pool bottom cleaning time, and the waterline cleaning index is 3, the pool wall cleaning index is 2, and the pool bottom cleaning index is 10. In this case, the calculation mode of the index increment includes: 3×5×N, wherein N is an incremental coefficient, the cleaning efficiency of which is usually above 90% when the underwater robot is cleaning waterlines or pool walls, on the basis of which the incremental coefficient is 0.1, the index increment thus calculated is 1.5. In this case, the pool bottom congestion index changes from 10 to 11.5. It should be noted that the above parameters are only used for explanation and are not intended to limit this embodiment.

Optionally, referring to FIG. 2, FIG. 2 is a relationship between a clogging value of a filter screen and cleaning time when an underwater robot first cleans a pool bottom. The time period 0-t1 is the change of the clogging value when the underwater robot cleans at a constant speed along a preset route, wherein t1 means that the underwater robot completes the cleaning of the pool bottom at this moment, that is, when the underwater robot completes the cleaning of the pool bottom, the clogging value is y1. The time period t1-t2 represents the time it takes for the underwater robot to move from the position where the pool bottom cleaning is completed to a preset wall climbing position after the underwater robot completes the pool bottom cleaning. This time period is recorded as the pool bottom cleaning time, that is, time t2 is the pool bottom cleaning time. Therefore, when the clogging value is calculated, if the clogging value is calculated directly based on t2 given in the historical cleaning time, the resulting clogging value is y2 as shown in FIG. 2, which is completely different from the actual clogging value y1. Therefore, to avoid overflow of the water pumping power when the underwater robot executes subsequent wall climbing actions or obstacle avoidance actions due to misjudgment of the clogging value, the underwater robot further divides the cleaning time in the historical cleaning data. For example, after the underwater robot executes the pool bottom cleaning, the current time is recorded through a preset instruction, and then the underwater robot acquires the historical cleaning data and determines the actual time for completing the pool bottom cleaning based on the preset instruction.

Step S23: determining the current clogging value according to the first congestion value, the second congestion value and the third congestion value.

Specifically, the sum of the pool bottom congestion value, the waterline congestion value, and the pool wall congestion value may be used as the current clogging value.

Optionally, the current clogging value may also be calculated from a current water pumping rate and a current water discharge rate of the underwater robot. That is, when cleaning the pool bottom, the underwater robot may acquire the current water pumping rate and the current water discharge rate, calculate a difference or a quotient between the water pumping rate and the water discharge rate, then acquire a mapping relationship between the clogging value stored in the database and the difference or the quotient, and finally acquire the clogging value of the filter screen of the water pumping mechanism based on the mapping relationship.

Step S30: when the underwater robot executes a climbing action and/or an obstacle avoidance action, determining a target value of a water pumping power according to the current clogging value, and executing the climbing action and/or the obstacle avoidance action according to the target value of the water pumping power.

In this embodiment, the climbing action refers to the underwater robot currently preparing to climb to the wall of the swimming pool. The obstacle avoidance action refers to the obstacles that the underwater robot detects and needs to avoid when performing the cleaning tasks, such as a handrail and a floor drain.

For example, after the clogging value is calculated, if the underwater robot needs to execute a climbing action to climb to a wall, a target value of the water pumping power may be determined based on the target clogging value, and the underwater robot executes the climbing action according to the target value of the water pumping power. After a period of time when the underwater robot climbs to the pool wall, if a handrail is detected in front of the underwater robot, the water pumping power needs to be adjusted again in this case to avoid the obstacle. It should be noted that the clogging value of the filter screen of the underwater robot only affects the pool wall cleaning, i.e., the climbing power during climbing the wall and the extra power required during obstacle avoidance, and when the pool bottom is cleaned, the traveling power of the underwater robot is mainly from a traveling motor and is basically not related to the clogging degree of the filter screen.

According to the technical solution disclosed in this embodiment, when the underwater robot executes an underwater cleaning task, the cleaning time of each area in the swimming pool is determined according to historical cleaning data, the clogging index of each cleaning area is selected based on the cleaning sequence, and the clogging value of the filter screen of the water pumping mechanism is calculated according to the clogging index and the cleaning time of each area, so that the underwater robot can execute the climbing action and/or the obstacle avoidance action based on the target value of the water pumping power corresponding to the current clogging value; and further, this avoids the subsequent insufficient battery left caused by directly adjusting the water pumping power to the maximum when the underwater robot executes climbing and/or obstacle avoidance. Therefore, the water pumping power of the underwater robot is dynamically adjusted based on the clogging value of the filter screen, which can improve the battery life of swimming pool cleaning and ensure full coverage cleaning of all areas of the swimming pool.

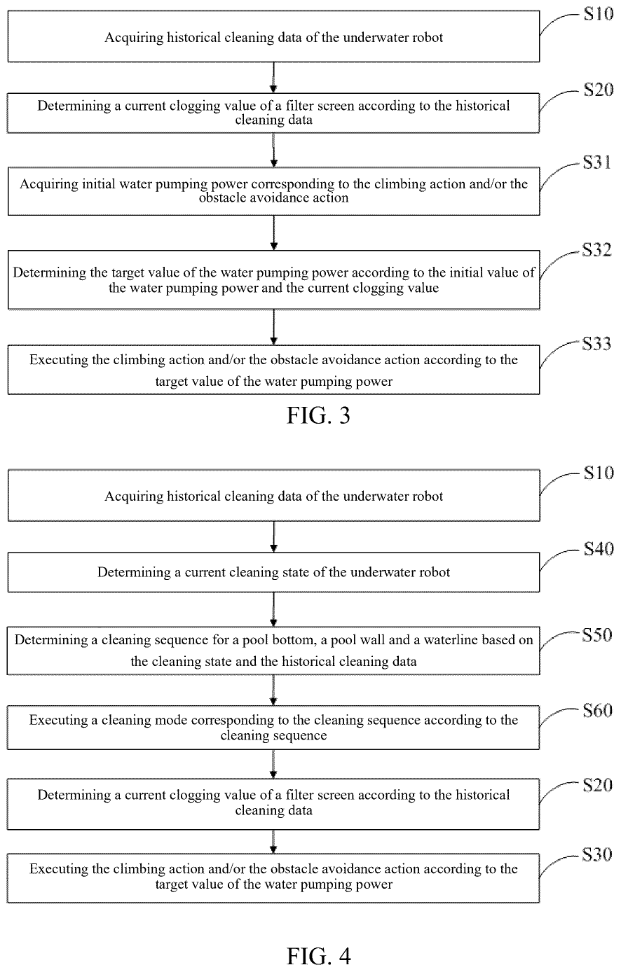

Referring to FIG. 3, in a second embodiment, based on the first embodiment, the step S30 includes:
step S31: acquiring initial water pumping power corresponding to the climbing action and/or the obstacle avoidance action;
step S32: determining the target value of the water pumping power according to the initial value of the water pumping power and the current clogging value; and
step S33: executing the climbing action and/or the obstacle avoidance action according to the target value of the water pumping power.

In this embodiment, when the underwater robot executes the climbing action and/or the obstacle avoidance action, the initial water pumping power is preset, and when the clogging value is 0, the underwater robot can complete the climbing action and the obstacle avoidance action based on the initial water pumping power. To prevent the clogging value of the filter screen from affecting the climbing power, it is necessary to determine the target value of the water pumping power according to the initial value of the water pumping power and the current clogging value.

For example, the initial water pumping power set by the underwater robot is 60%, and the detected clogging value is 15 in this case. In a data table stored locally by the underwater robot, when the clogging value is 15, the corresponding increment in the water pumping power is 25%, that is, the target value of the water pumping power is 85%. Optionally, when the clogging value is 15, the corresponding increment in the water pumping power is 40%, based on which the target value of the water pumping power is likewise approximately 85%. Therefore, when executing the climbing action, the underwater robot needs to use 85% of the water pumping power to execute climbing or obstacle avoidance actions.

It should be noted that the above data is only used for explanation and is not intended to limit the present application.

According to the technical solution disclosed in this embodiment, the target value of the water pumping power is determined by acquiring the initial water pumping power when the climbing and/or obstacle avoidance actions are executed and the current clogging value obtained by calculation, so that the accuracy of the target value of the water pumping power is guaranteed, and further the target water pumping power is more consistent with the power currently required by the underwater robot for climbing and/or avoiding obstacles, thereby improving the battery life of the underwater robot.

Referring to FIG. 4, in a third embodiment, based on the first embodiment, before the step S20, the method further includes:

Step S40: determining a current cleaning state of the underwater robot.

In this embodiment, the cleaning state refers to current state information of the underwater robot, including current acceleration, pitch angle, water exit state, and the like. The underwater robot can acquire the above parameters by a plurality of sensors and determine a cleaning sequence required to be executed when the swimming pool is cleaned according to the current state parameters. For example, the current pitch angle of the underwater robot detected by the inertial sensor is 90°, the acceleration detected by the acceleration sensor is 0, and the water exit detection device detects that the current position is on the water surface. Based on this, it may be determined that the underwater robot is currently in a wall climbing state, and the area corresponding to the wall climbing is the waterline area.

Step S50: determining a cleaning sequence for a pool bottom, a pool wall and a waterline based on the cleaning state and the historical cleaning data.

In this embodiment, after the cleaning state of the underwater robot is determined, the current cleaning sequence may be determined based on the historical cleaning data, for example, the underwater robot is currently positioned at the waterline. According to the historical cleaning data, the pool bottom cleaning time is 45 min, the pool wall cleaning time is 0 min, and the waterline cleaning time is 0 min, in this case, it may be determined that the underwater robot has completed cleaning of the pool bottom. Since the underwater robot is currently positioned at the water level area, it may be determined that the current cleaning sequence of the underwater robot is waterline-pool wall. It may be understood that, if the cleaning time corresponding to each area in the historical cleaning data is 0 min, and the current position is the waterline, the current cleaning sequence can be waterline-pool wall-pool bottom, or waterline-pool bottom-pool wall. Optionally, if the current position is the pool wall, the cleaning sequence can be pool wall-waterline-pool bottom and pool wall-pool bottom-waterline. It should be noted that the above data is only used for explanation and is not intended to limit the present application.

Step S60: executing a cleaning mode corresponding to the cleaning sequence according to the cleaning sequence.

In this embodiment, the cleaning area of the pool bottom in the swimming pool is usually greater than those of the pool wall and the waterline, and the to-be-cleaned objects in the pool bottom are usually more than those to be cleaned in the pool wall and the waterline. Therefore, if the underwater robot cleans the pool bottom first and then the pool wall and waterline, after the pool bottom is cleaned, the current clogging value of the filter screen of the underwater robot is high, which causes that the target value of the water pumping power acquired is 100% based on the target clogging value when the underwater robot executes climbing or obstacle avoidance, and the underwater robot may slide when cleaning the pool wall or waterline. Alternatively, the current blockage value is high, and even if the 100% water pumping power is activated, the underwater robot still cannot climb to the pool wall, resulting in the inability to complete the full coverage cleaning of the swimming pool. Therefore, to ensure the full coverage cleaning of the swimming pool, the cleaning sequence of the underwater robot can be set to be waterline-pool wall-pool bottom. In this cleaning sequence, the clogging value of the filter screen is calculated from 0, and the condition that the water pumping power is overflowed or insufficient can be greatly reduced.

Therefore, based on the cleaning sequence of waterline-pool wall-pool bottom, the current cleaning mode is the waterline cleaning mode, and the step S60 specifically includes:

Step S61: when a current position is not in a waterline area, controlling the underwater robot to climb to the waterline area.

Since the current cleaning mode is waterline cleaning mode, if the current position is not in the waterline area, the underwater robot needs to climb to the waterline area.

For example, when the underwater robot is positioned at the pool bottom, a laser sensor of the underwater robot continuously detects the position ahead, and when a distance to the pool wall is detected to be less than 30 cm, the underwater robot approaches the pool wall and executes a wall climbing action based on preset water pumping power. Then, the pitch angle of the underwater robot when climbing the wall is acquired based on the inertial sensor, and when the pitch angle is greater than 60°, it is indicated that the wall climbing is not affected. In this case, the underwater robot continues to climb until it detects the water exit signal sent by the water exit detection device and then stops climbing. This indicates that the underwater robot has currently climbed to the waterline area. If the underwater robot is currently positioned in the waterline area, the step S62 can be executed.

Step S62: when the current position is in the waterline area, turning off a left water pumping mechanism or a right water pumping mechanism of the underwater robot based on a preset cleaning route.

According to an optional implementation of this embodiment, the underwater robot completes the cleaning of the waterline by moving left and right, that is, when the underwater robot is positioned at the waterline, the direction corresponding to the head of the underwater robot is perpendicular to the cleaning direction of the waterline, and the left water pumping mechanism or the right water pumping mechanism needs to be started, and the underwater robot moves left and right based on the power provided by the left water pumping mechanism or the right water pumping mechanism during operation, so as to complete the cleaning. When cleaning the waterline, the underwater robot also reads the state information of the inertial sensor in real time, and determines the pitch angle of the underwater robot when cleaning the waterline based on the state information. It may be understood that the pitch angle of the underwater robot is 90° when cleaning the waterline. If it is detected that the current pitch angle is less than a first preset pitch angle, for example, 45°, it is judged that the underwater robot is in a trapped state or an abnormal state of a sensor at the current position preliminarily, and the underwater robot executes a backward action in this case, which includes gradually retreating from the current position to the pool bottom. During the retreating, if it is detected that the pitch angle is less than a second preset pitch angle, such as 20°, it is indicated that the current retreat direction is accurate. In this case, the retreat heading is locked and retreats to the pool bottom based on the retreat heading. It should be noted that the above data is only used for explanation and is not intended to limit the present application.

Optionally, when the underwater robot cleans the waterline of a quadrilateral swimming pool, if the acceleration sensor detects a large acceleration within a preset time while the underwater robot is moving left or right, it can be considered that the waterline of the current wall has been cleaned. In this case, the underwater robot may rotate 90°, climb from this wall to another wall, and then rotate −90°, and then continue to move left and right to clean the waterline of the current wall. When planning the cleaning routes for each area, the underwater robot determines the number of switches when cleaning another wall based on the shape of the pool currently to be cleaned.

For example, the underwater robot executing the waterline cleaning mode is specifically as follows: when climbing to the waterline, the underwater robot keeps the current posture, and needs to clean to the left for 25 seconds and clean to the right for 40 seconds based on the current state analysis. Therefore, the underwater robot turns off the left water pumping mechanism, starts to move to the left, restarts the left water pumping mechanism when the time exceeds 25 seconds, turns off the right water pumping mechanism, and stops moving after 65 seconds. Since the edge area of the swimming pool is usually provided with the handrail, and the underwater robot may be positioned above the handrail after moving for 65 seconds to the right, the underwater robot needs to move left for 4 seconds to prevent the handrails from affecting the backward movement of the underwater robot. During the cleaning process, the underwater robot acquires the clogging value of the filter screen and the change of the current pitch angle in real time based on the current cleaning time. During the cleaning process, if the pitch angle is less than 45° in the cleaning process, it is considered that the waterline is abnormal. In this case, the corresponding backward action is executed and the number of abnormalities is recorded. If the number of abnormalities is greater than 4, the underwater robot directly exits the waterline cleaning mode and enters the pool wall cleaning mode. When reaching the end of the current pool wall, the underwater robot switches to another wall and re-executes the waterline cleaning step.

It should be noted that the above data is only used for explanation and is not intended to limit the present application.

Step S63: when a first cleaning time for executing the waterline cleaning mode is greater than a first preset time and/or a heading angle of the underwater robot changes, controlling the underwater robot to enter a pool wall cleaning mode.

In this embodiment, after the underwater robot executes the action for a preset cleaning time, or when the heading angle changes from 90° to 45° at least, the cleaning mode can be switched, that is, the pool wall cleaning mode is entered based on the cleaning sequence of waterline-pool wall-pool bottom. For example, when executing the waterline cleaning mode for 30 min, the underwater robot automatically switches to the pool wall cleaning mode and adjusts the water pumping power based on the current clogging value.

When the pool wall cleaning mode is executed, the cleaning difficulty of the area closest to the pool bottom is large (for example, the area to be cleaned when the underwater robot has a pitch angle from 0° to 70°, hereinafter referred to as the area A). When the pool wall is cleaned, the underwater robot may be controlled to execute preliminary cleaning on the area with a pitch angle below 70°, and then clean all areas of the pool wall. That is to say, when the underwater robot climbs to the pool wall from the pool bottom, the pitch angle increases from 0, and when the pitch angle changes to 70°, the underwater robot executes the backward action and retreats to the pool bottom. After executing preliminary cleaning on the area A, the underwater robot cleans the submerged area according to the preset cleaning route. It should be noted that the above data is only used for explanation and is not intended to limit the present application.

Similarly, when cleaning the pool wall, the underwater robot determines a pitch angle when the underwater robot climbs the pool wall according to test parameters of the inertial sensor, and if a change value of the pitch angle is greater than a preset pitch angle such as 80° in a preset time window, it is considered that the underwater robot has a climbing failure. For example, in a case where there are many steps in a swimming pool, when the underwater robot climbs from the submerged area to the steps, the pitch angle usually changes from 90° to 0°, or when the battery level is low, the underwater robot slides from the pool wall to the pool bottom, and the pitch angle also changes from 90° to 0°. In this case, it can be considered that the current climbing has failed. The number of climbing failures can be recorded. When the number of climbing failures is greater than the preset number of failures, such as 2 times, the current state is changed to insufficient power connection state or trapped state, and an alarm prompt is output.

For example, the underwater robot executing the pool wall cleaning mode is specifically as follows: after switching to the pool wall cleaning mode, the underwater robot remains stationary for 3 seconds to determine current position, and if the current position is at the pool wall, the underwater robot returns to the pool bottom and finds a corresponding climbing position based on the preset cleaning route to climb to the pool wall. And if the current position is at the pool bottom, after determining the climbing position, the underwater robot executes a wall climbing action based on the current clogging value. During the process of climbing the wall for cleaning, when the pitch angle of the underwater robot changes from 0° to 70°, the underwater robot executes a backward movement to return to the pool bottom, then moves to the left or right, and cleans the area of the pool wall with the pitch angle of below 70° again. After this area is cleaned, the underwater robot climbs directly to the pool wall, making the pitch angle 90°, and cleans while moving. When the underwater robot fails to climb and returns to the pool bottom when encountering a secondary platform, the current number of failures is recorded. When the number of failures exceeds 4 times, the underwater robot exits the cleaning mode of the pool wall immersion area and enters the pool bottom cleaning mode for cleaning. In this process, the underwater robot acquires the clogging value in real time and adjusts the water pumping power in real time based on the clogging value.

It should be noted that the above data is only used for explanation and is not intended to limit the present application.

Optionally, after the step S63, the method further includes: step S64: when a second cleaning time for executing the pool wall cleaning mode is greater than a second preset time and/or a number of cleaning failures of the pool wall cleaning is greater than or equal to a preset number, controlling the underwater robot to enter a pool bottom cleaning mode.

In this embodiment, when the underwater robot has executed actions based on the pool wall cleaning mode for a preset cleaning time or the number of cleaning failures is greater than 4 times, the underwater robot can switch the cleaning mode, that is, enter the pool bottom cleaning mode based on the cleaning sequence of waterline-pool wall-pool bottom.

For example, the underwater robot executing the pool bottom cleaning mode is specifically as follows: after completing the pool wall cleaning, the underwater robot enters the pool bottom cleaning mode. During the cleaning process, the underwater robot continuously acquires signals from a plurality of sensors such as a laser sensor and an acceleration sensor and makes abnormal judgments, and the underwater robot repairs the course when the heading deviates, and performs full-power backward action when reaches the end of the swimming pool or detecting a non-plane. When a distance to the pool wall or other obstacles is detected to be less than 40 cm, or no distance change is detected within 150 seconds, or the distance change value exceeds 50 cm within 10 seconds, it may be considered that the underwater robot is in an abnormal situation. In this case, the underwater robot can execute escape actions such as moving left and right or retreating at full power, thereby ensuring that the underwater robot can complete the cleaning of the pool bottom.

It should be noted that the above data is only used for explanation and is not intended to limit the present application.

According to the technical solution disclosed in this embodiment, to ensure that the underwater robot can successfully complete the full coverage cleaning of the swimming pool, the waterline cleaning mode, pool wall cleaning mode and pool bottom cleaning mode are executed in sequence based on the cleaning sequence of waterline-pool wall-pool bottom. When the underwater robot faces various abnormal situations during the execution of each mode, corresponding response plans are provided, thereby improving the effect of full coverage cleaning of the swimming pool.

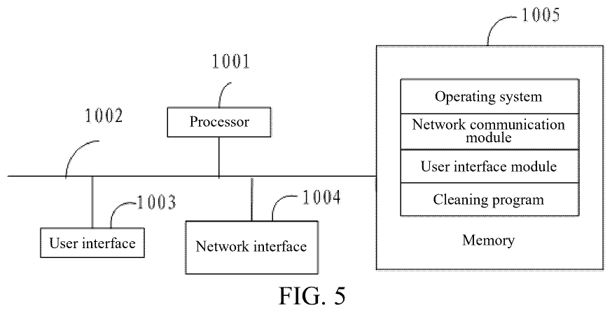

Referring to FIG. 5, FIG. 5 is a schematic diagram of a terminal structure of a hardware operating environment according to an embodiment of the present application.

As shown in FIG. 5, the terminal may include: a processor 1001 such as a CPU, a network interface 1004, a user interface 1003, a memory 1005, and a communication bus 1002. The communication bus 1002 is configured to implement connection and communication between these components. The user interface 1003 may include a display and an input unit such as a keyboard. Optionally, the user interface 1003 may also include a standard wired interface and a wireless interface. The network interface 1004 may optionally include a standard wired interface, and a wireless interface (e.g., a WI-FI interface). The memory 1005 may be a high-speed RAM memory or a non-volatile memory such as a disk memory. Optionally, the memory 1005 may be a storage device separate from the processor 1001.

Those skilled in the art may understand that the terminal structure shown in FIG. 5 does not constitute any limitation on the terminal. The terminal may include more or fewer components than those shown in the figure, or some components may be combined, or a different component deployment may be used.

As shown in FIG. 5, a memory 1005, as a computer storage medium, may include an operating system, a user interface module, a network communication module, and a cleaning program.

In the terminal shown in FIG. 5, the network interface 1004 is mainly used to connect a background server and perform data communication with the background server; and the processor 1001 may call a cleaning program stored in the memory 1005 and perform the following operations:
acquiring historical cleaning data of the underwater robot;
determining a current clogging value of a filter screen according to the historical cleaning data; and
when the underwater robot executes a climbing action and/or an obstacle avoidance action, determining target value of the water pumping power according to the current clogging value, and executing the climbing action and/or the obstacle avoidance action according to the target value of the water pumping power.

Further, the processor 1001 may call a cleaning program stored in the memory 1005 and perform the following operations:
determining a pool bottom cleaning time, a waterline cleaning time, and a pool wall cleaning time based on the historical cleaning data;
calculating a first congestion value according to the pool bottom cleaning time and a first congestion index, calculating a second congestion value according to the waterline cleaning time and a second congestion index, and calculating a third congestion value according to the pool wall cleaning time and a third congestion index; and
determining the current clogging value according to the first congestion value, the second congestion value and the third congestion value.

Further, the processor 1001 may call a cleaning program stored in the memory 1005 and perform the following operations:
if a pool wall cleaning mode and/or a waterline cleaning mode are executed before a pool bottom cleaning mode is executed, determining index increment according to the waterline cleaning time and the pool wall cleaning time; and
determining the first congestion index according to a preset index and the index increment.

Further, the processor 1001 may call a cleaning program stored in the memory 1005 and perform the following operations:
when a climbing action executing condition is met, controlling the underwater robot to execute the climbing action, and/or executing the obstacle avoidance action when detecting an obstacle.

Further, the processor 1001 may call a cleaning program stored in the memory 1005 and perform the following operations:
acquiring initial water pumping power corresponding to the climbing action and/or the obstacle avoidance action;
determining the target value of the water pumping power according to the initial water pumping power and the current clogging value; and
executing the climbing action and/or the obstacle avoidance action according to the target value of the water pumping power.

Further, the processor 1001 may call a cleaning program stored in the memory 1005 and perform the following operations:
determining a current cleaning state of the underwater robot;
determining a cleaning sequence for a pool bottom, a pool wall and a waterline based on the cleaning state and the historical cleaning data; and
executing a cleaning mode corresponding to the cleaning sequence according to the cleaning sequence.

Further, the processor 1001 may call a cleaning program stored in the memory 1005 and perform the following operations:
when a current position is not in a waterline area, controlling the underwater robot to climb to the waterline area;
when the current position is in the waterline area, turning off a left water pumping mechanism or a right water pumping mechanism of the underwater robot based on a preset cleaning route; and
when a first cleaning time for executing the waterline cleaning mode is greater than a first preset time and/or a heading angle of the underwater robot changes, controlling the underwater robot to enter a pool wall cleaning mode.

Further, the processor 1001 may call a cleaning program stored in the memory 1005 and perform the following operations:
when a second cleaning time for executing the pool wall cleaning mode is greater than a second preset time and/or a number of cleaning failures of the pool wall cleaning is greater than or equal to a preset number, controlling the underwater robot to enter a pool bottom cleaning mode.

In addition, those of ordinary skill in the art can understand that all or part of the processes in the method of the above embodiment can be completed by instructing related hardware through a computer program. The computer program includes program instructions, and the computer program may be stored in a storage medium that is a computer-readable storage medium. The program instructions are executed by at least one processor in the control terminal to implement the process steps of the embodiment of the above method.

Therefore, the present application further provides a computer-readable storage medium on which a cleaning program of an underwater robot is stored, wherein when the cleaning program of the underwater robot is executed by a processor, the steps of the cleaning method for the underwater robot described in the above embodiment are implemented.

It should be noted that, since the storage medium provided in the embodiment of the present application is the storage medium used to implement the method of the embodiment of the present application, based on the method introduced in the embodiment of the present application, those skilled in the art can understand the specific structure and deformation of the storage medium, and details are not described herein again. Any storage medium used in the method of the embodiment of the present application is within the protection scope of the present application.

It should be appreciated by those skilled in the art that embodiments of the present application may be provided as a method, a system, or a computer program product. Therefore, the present application may use a form of hardware only embodiments, software only embodiments, or embodiments with a combination of software and hardware. In addition, the present application may use a form of a computer program product that is implemented on one or more computer-usable storage media (including but not limited to a disk memory, a CD-ROM, and an optical memory) that include computer-usable program code.

The present application is described with reference to the flowcharts and/or block diagrams of the method, the device (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may alternatively be stored in a computer-readable memory that can instruct a computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto the computer or another programmable data processing device, so that a series of operations and steps are performed on the computer or another programmable device, to generate computer-implemented processing. Therefore, the instructions executed on the computer or another programmable device provide steps for implementing a specific function in one or more processes in the flowcharts and/or in one or more blocks in the block diagrams.

It should be noted that, in the claims, any reference signs placed between parentheses shall not be constructed as limiting the claim. The word “comprise” does not exclude the presence of elements or steps not listed in the claim. The word “a” or “an” preceding an element does not exclude the presence of a plurality of such elements. The present application can be implemented by means of hardware including several distinct elements, and by means of a suitably programmed computer. In a unit claim enumerating several means, several of these means may be embodied by the same item of hardware. The usage of the words such as “first”, “second” and “third” do not indicate any order. These words may be interpreted as names.

Although some preferred embodiments of the present application have been described, those skilled in the art can make changes and modifications to these embodiments after learning the basic inventive concept. Therefore, the appended claims are intended to be construed as including the preferred embodiments and all changes and modifications that fall within the scope of the present application.

It is clear that those skilled in the art can make various modifications and variations to the present application without departing from the spirit and scope of the present application. In this way, the present application is intended to cover these modifications and variations of the present application provided that these modifications and variations fall within the scope of protection defined by the following claims and their equivalent technologies.

The above mentioned contents are merely preferred embodiments of the present application and are not intended to limit the patent scope of the present application. The equivalent structure or equivalent process transformation made by using the contents of the specification and the drawings of the present application, or direct or indirect applications to other related technical fields, are all included in the patent protection scope of the present application.

1. A cleaning method applied to an underwater robot, the underwater robot comprising a water pumping mechanism comprising a filter screen, the cleaning method comprising:
acquiring historical cleaning data of the underwater robot;
determining a current clogging value of the filter screen according to the historical cleaning data; and
when the underwater robot executes a climbing action and/or an obstacle avoidance action,
determining a target value of a water pumping power according to the current clogging value, and
executing the climbing action and/or the obstacle avoidance action according to the target value of the water pumping power.

2. The cleaning method applied to the underwater robot according to claim 1, wherein determining the current clogging value of the filter screen according to the historical cleaning data comprises:
determining a pool bottom cleaning time, a waterline cleaning time, and a pool wall cleaning time based on the historical cleaning data;
calculating a first congestion value according to the pool bottom cleaning time and a first congestion index, calculating a second congestion value according to the waterline cleaning time and a second congestion index, and calculating a third congestion value according to the pool wall cleaning time and a third congestion index; and
determining the current clogging value according to the first congestion value, the second congestion value and the third congestion value.

3. The cleaning method applied to the underwater robot according to claim 2, wherein before the calculating the first congestion value according to the pool bottom cleaning time and the first congestion index, calculating the second congestion value according to the waterline cleaning time and the second congestion index, and calculating the third congestion value according to the pool wall cleaning time and the third congestion index, the method further comprises:
if a pool wall cleaning mode and/or a waterline cleaning mode are executed before a pool bottom cleaning mode is executed, determining an index increment according to the waterline cleaning time and the pool wall cleaning time; and
determining the first congestion index according to a preset index and the index increment.

4. The cleaning method for the underwater robot according to claim 1, wherein before determining the target value of the water pumping power according to the current clogging value and executing the climbing action and/or the obstacle avoidance action according to the target value of the water pumping power, the method further comprises:
when a climbing action executing condition is met, controlling the underwater robot to execute the climbing action, and/or executing the obstacle avoidance action when detecting an obstacle.

5. The cleaning method applied to the underwater robot according to claim 1, wherein determining the target value of the water pumping power according to the current clogging value and executing the climbing action and/or the obstacle avoidance action according to the target water pumping power comprises:
acquiring an initial value of a water pumping power corresponding to the climbing action and/or the obstacle avoidance action;
determining the target value of the water pumping power according to the initial value of the water pumping power and the current clogging value; and
executing the climbing action and/or the obstacle avoidance action according to the target value of the water pumping power.

6. The cleaning method applied to the underwater robot according to claim 1, wherein before determining a current clogging value of a filter screen according to the historical cleaning data, the method further comprises:
determining a current cleaning state of the underwater robot;
determining a cleaning sequence for a pool bottom, a pool wall and a waterline based on the cleaning state and the historical cleaning data; and
executing a cleaning mode corresponding to the cleaning sequence according to the cleaning sequence.

7. The cleaning method applied to the underwater robot according to claim 6, wherein the cleaning mode is a waterline cleaning mode, and executing the cleaning mode corresponding to the cleaning sequence according to the cleaning sequence comprises:
when a current position is not in a waterline area, controlling the underwater robot to climb to the waterline area;
when the current position is in the waterline area, turning off a left water pumping mechanism or a right water pumping mechanism of the underwater robot based on a preset cleaning route; and
when a first cleaning time of executing the waterline cleaning mode is greater than a first preset time and/or a heading angle of the underwater robot changes, controlling the underwater robot to switch to a pool wall cleaning mode.

8. The cleaning method applied to the underwater robot according to claim 7, after controlling the underwater robot to switch to the pool wall cleaning mode when a first cleaning time for executing the waterline cleaning mode is greater than a first preset time and/or a heading angle of the underwater robot changes, the method further comprises:
when a second cleaning time of executing the pool wall cleaning mode is greater than a second preset time and/or a number of cleaning failures of the pool wall cleaning is greater than or equal to a preset number, controlling the underwater robot to switch to a pool bottom cleaning mode.

9. An underwater robot comprising: a memory, a processor, and a cleaning program of the underwater robot stored in the memory and capable of running on the processor, wherein when the cleaning program of the underwater robot is executed by the processor, the processor executes instructions as follows:
acquiring historical cleaning data of the underwater robot;
determining a current clogging value of a filter screen according to the historical cleaning data; and
when the underwater robot executes a climbing action and/or an obstacle avoidance action,
determining a target value of a water pumping power according to the current clogging value, and
executing the climbing action and/or the obstacle avoidance action according to the target value of the water pumping power.

10. A computer-readable storage medium on which a cleaning program of an underwater robot is stored, wherein when the cleaning program of the underwater robot is executed by a processor, the processor executes instructions as follows:
acquiring historical cleaning data of the underwater robot;
determining a current clogging value of a filter screen according to the historical cleaning data; and
when the underwater robot executes a climbing action and/or an obstacle avoidance action,
determining a target value of a water pumping power according to the current clogging value, and
executing the climbing action and/or the obstacle avoidance action according to the target value of the water pumping power.
